(19) United States
(12) Patent Application Publication
(10) Pub. No.: US 2012/0137673 A1
(43) Pub. Date: Jun. 7, 2012

(54) Brake System for Motor Vehicles

(76) Inventor: Stefan A. Drumm, Saulheim (DE)

(21) Appl. No.: 13/389,556

(22) PCT Filed: Aug. 4, 2010
(86) PCT No.: PCT/EP2010/061327

§ 371 Date: Feb. 8, 2012

(30) Foreign Application Priority Data
Aug. 14, 2009 (DE) 102209028551.2
Jul. 23, 2010 (DE) 102010038327.9

(51) Int. Cl. F15B 7/00

(52) U.S. Cl. 60/545

(57) ABSTRACT

A brake system for motor vehicle having a system for reducing brake pedal travel. The system having an electronic control and regulating unit (11), a brake pedal (9) having an amplifier chamber (13), a travel detecting device (14), a main brake cylinder (3) with at least one pressure chamber, a brake circuit (I, II), an electrically controllable pressure supply device (18, 19), a pressure regulating valve (20), and a cylinder-piston arrangement (8) for reducing pedal travel. The cylinder-piston arrangement (8) is disposed separately from the brake force amplifier (18; 20; 13; 6) and from the main brake cylinder (3).

### CROSS REFERENCE TO RELATED APPLICATIONS

This application claims priority to German Patent Application Nos. 10 2009 028 551.2, filed Aug. 14, 2009, 10 2010 038 327.9, filed Jul. 23, 2010, and PCT/EP2010/061327, filed Aug. 4, 2010.

### FIELD OF THE INVENTION

The present invention relates to a brake system for motor vehicles, having a device for shortening pedal travel.

### BACKGROUND OF THE INVENTION

A brake system of the above-referenced type is known for example from the German patent DE 36 27 147 C2. A disadvantage of the known brake system is the considerable axial structural length of the combination of the hydraulic brake force booster with the master brake cylinder which is formed as a tandem master cylinder and in the housing of which the cylinder-piston arrangement is integrated coaxially.

It is therefore an object of the present invention to provide for a reduction in the axial structural length of the abovementioned combination.

The above object is achieved according to the invention in that the cylinder-piston arrangement is arranged separately from the brake force booster and the master brake cylinder.

Advantageous refinements of the subject matter of the invention are further provided in accordance with this invention.

A disablement or a modification of the pedal travel shortening obtained with the subject matter of the invention is may be provided for example during so-called recuperation braking operations in which a part of the braking action demanded via the depression of the brake pedal is generated by an electric traction drive operating in the generator mode, the friction brake system contributes only the remaining difference in deceleration, and the familiar dependency of the brake pedal position on the force exerted on the brake pedal is produced by means of an electronically controlled modification of the pedal travel. This feature is preferably realized by virtue of an electrically actuable 2/2 directional control valve being positioned in the hydraulic connection for charging the cylinder-piston arrangement with the boost pressure.

According to another feature of the subject matter of the invention, a disablement of the pedal-controlled activation of the pressure regulating valve, which is expedient for example during so-called recuperation braking operations is achieved in that an electrically actuable 2/2 directional control valve which is open in the deenergized state is positioned in the activation line between a second control port and the pressure chamber and, in the actuated switching position, performs the function of a check valve which blocks in the direction of the pressure regulating valve.

### BRIEF DESCRIPTION OF THE INVENTION

The present invention will be explained in more detail below on the basis of two exemplary embodiments and with reference to the appended schematic drawing, wherein identical components are provided with the same reference symbols. In the drawing:

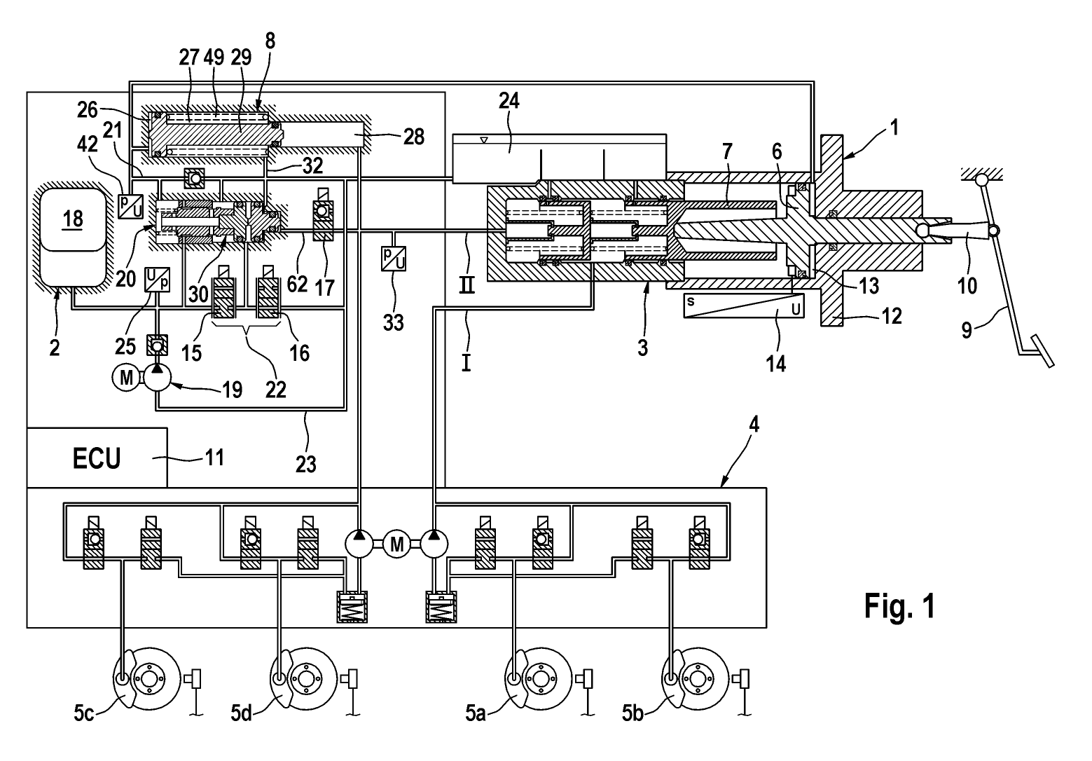

FIG. 1 shows the design of a first embodiment of the brake system according to the invention,

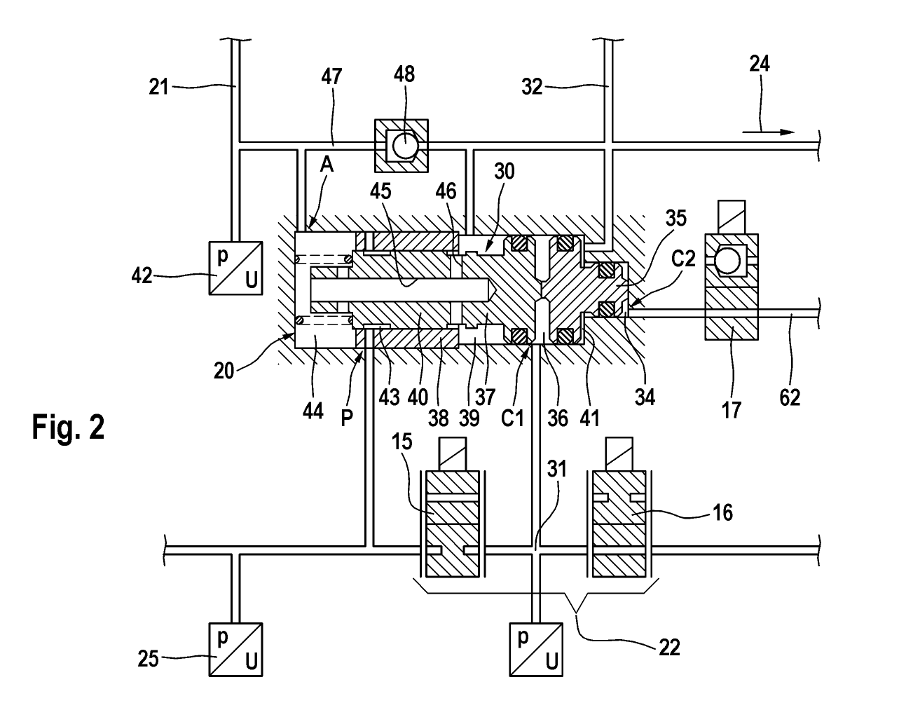

FIG. 2 shows an important part of the brake force booster used in the brake system according to FIG. 1, on an enlarged scale, and

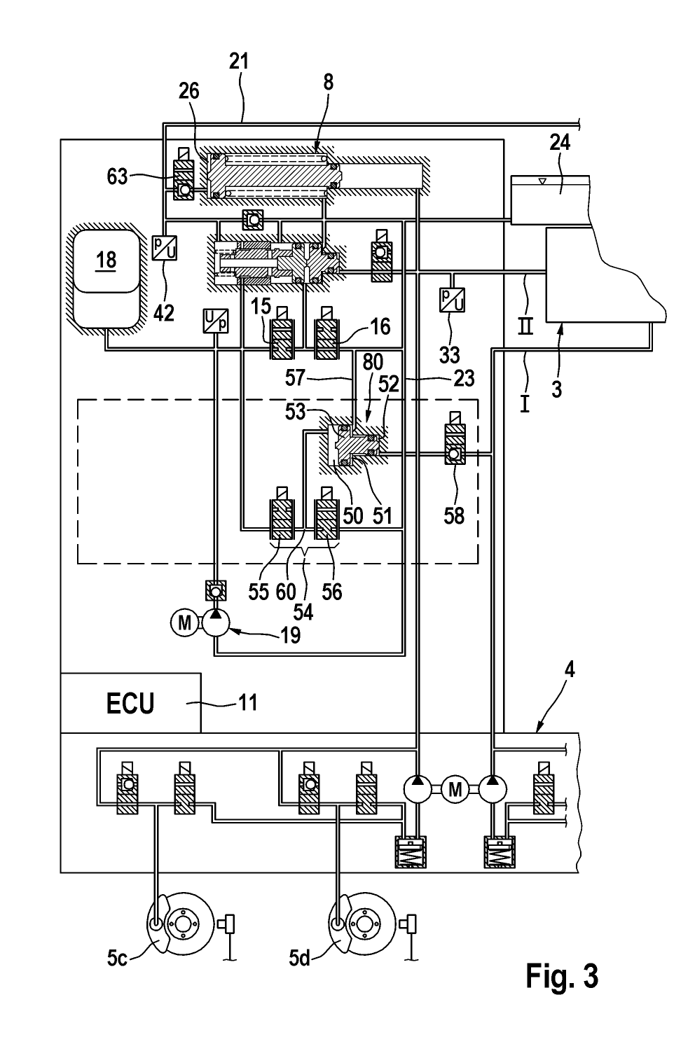

FIG. 3 shows the design of a second embodiment of the brake system according to the invention.

### DETAILED DESCRIPTION OF THE INVENTION

The electrohydraulic brake system illustrated by way of example in FIG. 1 is composed substantially of an actuating unit 1, of an electrically controllable pressure generating device 2, wherein the actuating unit 1 and the pressure generating device 2 form a brake force booster, and of a master brake cylinder or tandem brake cylinder 3 which is positioned operatively downstream of the brake force booster and to the pressure chambers (not shown in any more detail) of which are connected wheel brake circuits I and II which supply hydraulic pressure medium to wheel brakes 5a to 5d of a motor vehicle via a known ABS/ESP hydraulic unit or a controllable wheel brake pressure modulation module 4. Furthermore, the brake system has an electronic brake system control unit 11. For the activation of the brake actuating unit 1, a brake pedal 9 is provided to which is coupled a piston rod 10 which is connected in a force-transmitting manner via a booster piston 6 to a first piston or primary piston 7 of the master brake cylinder 1. The booster piston 6 is guided in an axially movable manner in a booster housing 12 and, in the latter, delimits a hydraulic booster chamber provided with the reference numeral 13. Signals from a travel sensor 14 which serves to detect a driver deceleration demand and which senses the actuating travel of the piston rod 10 are supplied to the electronic brake system control unit 11. From said signals, in the electronic brake system control unit 11, activation signals are prepared for electromagnetically actuable 2/2 directional control valves 15, 16, 17, the task of which will be explained in the text below, and for hydraulic pressure regulating valves contained in the wheel brake pressure modulation module 4.

The abovementioned pressure generating device 2 is formed, in the example shown, by a hydraulic high-pressure accumulator 18 with a downstream pressure regulating valve 20. A motor-pump unit 19 serves for charging the high-pressure accumulator 18. The outlet of the pressure regulating valve 20 is connected via a hydraulic connection 21 to the booster chamber 13 positioned upstream of the master brake cylinder 3. The pressure regulating valve 20 is assigned a pilot control stage 22, the task of which will be explained in the text below. A further line 23 connects the suction side of the motor-pump unit 19 to a pressure medium storage tank 24 assigned to the master brake cylinder 3. The motor-pump unit 19 can preferably be formed as an independent assembly and provided with fastenings and hydraulic connections which isolate body-borne vibration and sound. The hydraulic pressure stored in the high-pressure accumulator 18 is measured by a pressure sensor provided with the reference numeral 25.

It can also be seen from the drawing that a hydraulic cylinder-piston arrangement 8 is connected to one (II) of the wheel brake circuits I and II. The cylinder-piston arrangement 8 is formed by a first hydraulic chamber 26, a second hydraulic chamber 27, a third hydraulic chamber 28 and a stepped piston 29 which separates the chambers 26, 27 and 28 from one another. Here, the larger effective surface of the stepped piston 29 separates the first chamber 26 from the second chamber 27, while the third chamber 28 is delimited by the smaller effective surface of the stepped piston 29. Here, the first chamber 26 is connected to the abovementioned hydraulic line 21 which leads to the booster chamber 13, the second chamber 27 is connected via a further hydraulic connection 32 to the pressure medium reservoir 24, and the third chamber 28 is connected to the brake circuit provided with the reference symbol II. Arranged in the second chamber 27 there is a restoring spring 49 which holds the stepped piston 29 in an unpressurized state in the rest position shown. The pressure induced in the second brake circuit II is measured by means of a pressure sensor 33.

As can be seen in particular from FIG. 2 of the drawing, the pressure regulating valve 20 is of two-stage design and preferably has, aside from the said electrically actuable pilot control stage 22, a doubly hydraulically activatable valve main stage provided with the reference numeral 30, and a hydraulic activation stage, the design of which will be explained in the description below.

The pilot control stage 22 is composed of a series connection of the abovementioned 2/2 directional control valves 15 and 16 which are designed as analog-regulable 2/2 directional control valves. The former 2/2 directional control valve 15 is designed as a 2/2 directional control valve which is closed in the deenergized state, whereas the latter directional valve 16 is designed as a 2/2 directional control valve which is open in the deenergized state, wherein the hydraulic central tapping point 31 between the two valves 15 and 16 provides one of the activation pressures for the valve main stage 30 via a first control port C1. The hydraulic activation stage is formed by a first activation chamber 34, a first activation piston or stepped piston 35, an annular chamber 41 which is connected to the pressure medium storage tank 24, and a second activation chamber 36 which is delimited by the stepped piston 35 and which is connected to the abovementioned central tapping point 31 of the pilot control stage 22. The second activation chamber 36 is delimited at the other side by a second activation piston 37 which, together with a valve body 40, delimits a tank port chamber 39 and which, in the embodiment shown, is formed in one piece with a valve body 40 which is designed as a slide which has control edges. The valve sleeve 38 forms, together with the valve body 40, the abovementioned main stage 30 of the pressure regulating valve 20.

It can also be seen from FIG. 2 that the first activation chamber 34 is connected by means of a second control port C2 to the second brake circuit II via the electromagnetically actuable 2/2 directional control valve 17 which is open in the deenergized state, as mentioned in conjunction with FIG. 1. In its energized switching position, the 2/2 directional control valve 17, which is positioned in an activation line 62, performs the function of a check valve which closes in the direction of the control port C2, as indicated by the corresponding hydraulic symbol.

Meanwhile, the valve body 40 forms, together with the valve sleeve 38, a high-pressure port chamber 43 which is connected via a high-pressure port P to the high-pressure accumulator 18. By means of a displacement of the valve body 40, the high-pressure port chamber 43 is connected to a working pressure chamber 44 which forms the outlet, denoted by the letter A, of the pressure regulating valve 20 and which, in the illustrated starting position or rest position of the valve body 40, is connected to the tank port chamber 39 by means of pressure medium ducts 45 and 46 formed in the valve body 40. The boost pressure induced in the working pressure chamber 44 is measured by a third pressure sensor 42. Here, it is advantageous for the diameter of the valve body 40 which is guided in the valve sleeve 38 to be greater than the diameter of the smaller stage of the stepped piston 35. It also emerges from FIG. 2 that the abovementioned connecting line 21 which leads to the booster chamber 13, and the further line 47 which is connected to said connecting line and which leads to the pressure medium storage tank 24, are connected to the working pressure chamber 44. Here, a check valve 48 which closes in the direction of the pressure medium storage reservoir 24 is positioned in the line 47.

The design of the second exemplary embodiment of the brake system according to the invention substantially corresponds to that of the first exemplary embodiment illustrated in FIG. 1. Therefore, for better clarity, a detail of the second exemplary embodiment of the brake system according to the invention is shown in FIG. 3. The second exemplary embodiment of the present invention is suitable for motor vehicles in which so-called recuperation braking operations are carried out. Here, in the example, there is connected to the first brake circuit I a second cylinder-piston arrangement 80 which constitutes a device for producing an additional brake pedal travel. The second cylinder-piston arrangement 80 has a first hydraulic chamber 50, a second hydraulic chamber 51, a third hydraulic chamber 52 and a stepped piston 53. Here, the larger effective surface of the stepped piston 53 separates the first 50 from the second chamber 51, while the third chamber 52 is delimited by the smaller effective surface of the stepped piston 53. The first hydraulic chamber 50 is connected to the central tapping point 60 of a valve pair 54 which is formed by a series connection of two analog-regulable 2/2 directional control valves 55 and 56. The former 2/2 directional control valve 55 is designed as a valve which is open in the deenergized state and is preferably positioned between the first chamber 50 and the abovementioned high-pressure accumulator 18. The latter 2/2 directional control valve 56 is designed as a valve which is closed in the deenergized state and is preferably positioned between the first chamber 50 and the line 23 which leads to the pressure medium storage resevoir 24 (see also FIG. 1). The second hydraulic chamber 51 is connected via a line section 57 to the line 23 and therefore to the pressure medium storage tank 24, while the third chamber 52 is connected to the first brake circuit I via a 2/2 directional control valve 58. In the illustrated operating (rest) state, the 2/2 directional control valve 58 performs the function of a check valve which closes in the direction of the second cylinder-piston arrangement 80, whereas when the 2/2 directional control valve 58 is switched, the third chamber 52 is connected to the brake circuit I.

A disablement of the action of the first cylinder-piston arrangement 8 is made possible by an electromagnetically actuable 2/2 directional control switching valve 63 which is positioned between the first chamber 26 of the first cylinder-piston arrangement 8 and the hydraulic line 21. In the illustrated operating (rest) state, the 2/2 directional control switching valve 63 performs the function of a check valve which closes in the direction of the cylinder-piston arrangement 8.

The functioning of the illustrated brake system in the preferred “brake by wire” operating mode emerges to a person skilled in the art from the content of disclosure of the present documentation, and need not be explained in any more detail.

1. A brake system for motor vehicles, providing shortening of brake pedal travel, in an operating mode with brake force boosting by a boost pressure, and is inactive in shortening of brake pedal travel in an operating made without brake force boosting, the system comprising:
an electronic control and regulating unit (11),
a brake pedal (9) for actuating a hydraulic brake force booster (18; 20; 13; 6) with a booster chamber (13) in which a boost pressure acts,
a travel measuring device (14) which measures the actuating travel of the brake pedal (9),
a master brake cylinder (3) which is positioned operatively downstream of the brake force booster (18; 20; 13; 6) and which has at least one pressure chamber which is connected a brake circuit (I, II),
an electrically controllable pressure generating device (18, 19) for generating a supply pressure for the brake force booster,
a pressure regulating valve (20) which is connected to the supply pressure and which serves for regulating the boost pressure, and
a cylinder-piston arrangement (8) which serves for shortening brake pedal travel and which has two effective surfaces, one of which can be acted on by the pressure of the brake circuit (I or II) and the other of which can be acted on by the boost pressure, the cylinder-piston arrangement (8) is arranged separately from the brake force booster (18; 20; 13; 6) and the master brake cylinder (3).

2. The brake system as claimed in claim 1, further comprising in that a piston (29) of the piston-cylinder arrangement (8) is designed as a stepped piston forming the two effective surfaces, one of the effective surfaces being a larger effective surface of which is acted on with the boost pressure.

3. The brake system as claimed in claim 1, further comprising means for the electrically controlled enablement and disablement of the pedal-travel-shortening action of the piston-cylinder arrangement (8).

4. The brake system as claimed in claim 3, further comprising in that, for the enablement and disablement of the pedal travel shortening action, an electrically actuable 2/2 directional control valve (63) is positioned for charging the cylinder-piston arrangement (8) with the boost pressure.

5. The brake system as claimed in claim 2 further comprising in that the piston (29) of the cylinder-piston arrangement (8) is preloaded counter to the direction of action of the boost pressure by means of a restoring spring (49) arranged in a chamber (27) which is delimited by one of the effective surfaces and which is connected to a pressure medium reservoir (24) assigned to the master brake cylinder (3).

6. The brake system as claimed in claim 5 further comprising in that the pressure regulating valve (20) can be activated both by means of the brake pedal (9) and also electrically.

7. The brake system as claimed in claim 6, further comprising in that the activation of the pressure regulating valve (20) by means of the brake pedal (9) takes place via a hydraulic control port (C2) which is connected to the pressure chamber of the master brake cylinder (3).

8. The brake system as claimed in claim 7, further comprising in that an electrically actuable 2/2 directional control valve (17) which is open in the deenergized state is positioned in an activation line (62) between the hydraulic control port (C2) and the pressure chamber and, in an actuated switching position, performs the function of a check valve which blocks fluid flow in the direction of the pressure regulating valve (20).

9. The brake system as claimed in claim 6 further comprising in that the electric activation of the pressure regulating valve (20) takes place via a hydraulic first control port (C1) by means of an electromagnet-valve-controlled pressure which can be set via a hydraulic central tapping point (31) of a valve pair (15, 16).

10. The brake system as claimed in claim 9, further comprising in that the valve pair (15, 16) is formed by a first, analog-regulable 2/2 directional control valve (15) and a second, analog-regulable 2/2 directional control valve (16), wherein the first 2/2 directional control valve (15) is designed as a valve which is closed in a deenergized state and which permits a regulated opening-up of a connection between the pressure generating device (2) and the first control port (C1), whereas the second 2/2 directional control valve (16) is designed as a valve which is open in a deenergized state and which permits a regulated shut-off of a connection between the first control port (C1) and the pressure medium storage tank (24).

11. The brake system as claimed in claim 1 further comprising in that a device (80) for producing an additional brake pedal travel is provided.

12. The brake system as claimed in claim 11, further comprising in that the device for producing an additional pedal travel is designed as a second cylinder-piston arrangement (80) which can be acted on at one side at one of the brake circuit (I, II) and on the other side with an electromagnet-valve-controlled pressure which can be set via a central tapping point (61) of a second valve pair (55, 56).

13. The brake system as claimed in claim 12, further comprising in that the second cylinder-piston arrangement (80) has a second stepped piston (53), having a larger effective surface of which can be acted on with the electromagnet-valve-controlled pressure and a smaller effective surface of which can be acted on with the pressure induced in the brake circuit (I, II).

14. The brake system as claimed in claim 12 further comprising in that the second valve pair (55, 56) is formed by a third, analog-regulable 2/2 directional control valve (55) and a fourth, analog-regulable 2/2 directional control valve (56), wherein the third 2/2 directional control valve (55) is a valve which is open in a deenergized state and which permits a regulated shut-off of a connection between the pressure generating device (2) and a pressure chamber (50) delimited by the larger effective surface of the stepped piston (53), whereas the second 2/2 directional control valve (56) is a valve which is closed in a deenergized state and which permits a regulated opening-up of a connection between the pressure chamber (50) and the pressure medium storage tank (24).

15. The brake system as claimed in claim 13 further comprising a fourth electrically actuable 2/2 directional control valve (58) which is open in an energized state is positioned in the connection between the brake circuit (I, II) and a second pressure chamber (52) which is delimited by the smaller effective surface of the stepped piston (53), which 2/2 directional control valve (58), in a non-actuated switching position, performs the function of a check valve which blocks the flow of fluid in the direction of the second pressure chamber (52).
